(19) United States
(12) Patent Application Publication
(10) Pub. No.: US 2021/0155261 A1
(43) Pub. Date: May 27, 2021

(54) AUTOMATED DRIVING SYSTEM

(71) Applicants: TOYOTA MOTOR EUROPE, Brussels (BE); TECHNISCHE UNIVERSITÄT MÜNCHEN, Munich (DE)

(72) Inventors: Giancarlo CACCIA DOMINIONI, Brussels (BE); Martin GÖTZE, Garching (DE); Yucheng YANG, Garching (DE)

(21) Appl. No.: 16/610,820

(22) PCT Filed: May 5, 2017
(86) PCT No.: PCT/EP2017/060840

§ 371 Date: Nov. 4, 2019

(51) Int. Cl. B60W 60/00; B60Q 9/00; B60W 50/02

(52) U.S. Cl. CPC B60W 60/0013; B60Q 9/00; B60W 50/02; B60W 2520/10; B60W 2552/00; B60W 2555/20; B60W 2554/406; B60W 2554/408; B60W 2520/12

(57) ABSTRACT

An automated driving system comprising an electronic control unit and a driver stimulation device suitable for stimulating the driver by being activated according to at least one stimulation pattern.

In this automated driving system, the electronic control unit is configured to cause said driver stimulation device to be activated according to at least one periodical stimulation pattern, when the automated driving system is activated.

Such stimulation helps the driver to maintain his or her level of situation awareness at an appropriate level at all times.

### CROSS-REFERENCES TO RELATED APPLICATIONS

This application is a National Phase Application of International Application No. PCT/EP2017/060840, filed on May 5, 2017. The entire disclosure of the above application is incorporated herein by reference.

### FIELD

The present disclosure relates to an automated driving system.

An automated driving system is a motor vehicle driving automation system that is capable of performing part or all of the dynamic driving task (DDT) on a sustained basis.

An automated driving system can be mounted or is to be mounted in a car or a vehicle (such as a car, a truck, an airplane).

In the case of road vehicles in particular, it may range in level from no driving automation (level 0) to full driving automation (level 5) according to SAE norm J3016.

In order to realize this function, an automated driving system normally comprises at least one sensor, an electronic control unit, and feedback devices which transmit information to the driver and/or act on control member(s) of the vehicle (for instance the steering shaft, the brake, the accelerator pedal or the like) instead of the driver to take some driving load off the driver.

An automated driving system is at least capable of assuming part of the driving task (for instance, to perform longitudinal control of the vehicle). In particular, many automated driving systems are designed to assist the driver and are therefore called Advanced Driver Assistance Systems (ADAS). Some automated driving systems are capable of assuming the whole driving task, at least during some periods. Such systems are classified at level 3, 4 or 5 according to SAE norm J3016.

The present disclosure concerns an automated driving system classified at level 3 or 4 according to SAE norm J3016.

### BACKGROUND

During the periods when the automated driving system is activated, in many cases the driver still has to be able to be ready to take back control of his vehicle. Indeed, in some circumstances the automated driving system can possibly be unable to react properly to the circumstances; it is then necessary for the driver to take over within a certain time and to control his or her vehicle by braking, turning, etc., in order to avoid any accident.

Despite this obligation, during these periods and thanks to the automated driving system, the driver may perform to some extent non-driving-related tasks such as using his/her smartphone, texting, etc., but he or she still remains in the obligation to be able to safely take over at any moment.

Now, various studies have shown that drivers, when they perform non-driving related tasks, tend quickly to focus on the non-driving related-task; it becomes therefore soon more difficult for them to react and to take over if it becomes necessary to do so.

Consequently, there is a need for an automated driving system which makes it as easy as possible, for the driver, to remain ready and able to control his vehicle even when the automated driving system is activated and assumes part or all of the driving tasks.

### SUMMARY

According to the disclosure, in order to meet the above need, an automated driving system is proposed. This automated driving system comprises an electronic control unit and a driver stimulation device suitable for stimulating the driver by being activated according to at least one stimulation pattern; in addition, the electronic control unit is configured to cause the driver stimulation device to be activated according to at least one periodical stimulation pattern, when the automated driving system is activated.

Indeed, it has appeared that a device which stimulates the driver by being activated according to one or more periodical stimulation pattern(s) when the automated driving system is activated, suitably stimulates the driver by reminding him or her that the automated driving system is active and that the driver still has to keep some attention on the road and to maintain his or her traffic situation awareness at a sufficient level.

A periodical stimulation pattern is an event or a sequence of events which is periodically triggered by the electronic control unit in the driver stimulation device. This or these events can consist in transmitting signals under different forms to the driver; for instance a stimulation pattern can consist in emitting light, emitting sound(s), and/or emitting a haptic signal, the light and/or sound and/or haptic signal having predetermined selected features, and being received by the driver whose attention is therefore stimulated.

The at least one periodical stimulation pattern accordingly can comprise changing an intensity and/or a colour of light, changing an intensity and/or a type of sound, and/or changing an intensity and/or a type of haptic signal.

The driver stimulation device can therefore take up many forms. The driver stimulation device can comprise at least one stimulation signal-emitting element among a light source, a sound-emitting device, a haptic signal-emitting device. One or more of these elements can be combined. In particular, the driver stimulation device can comprise LEDs (light-emitting diodes), as light sources, for instance a stripe or bar of LEDs. The light source(s) can be located at various locations, for instance below or on the sides of the windscreen, in particular on the dashboard and/or the front pillars. In some embodiments, the light source(s) is located so as to be visible in a peripheral vision of the driver, when the driver watches the road in front of the vehicle or even when the driver looks away from the road, for example when using a smartphone on her/his lap.

In addition, the efficiency of the stimulation of the driver realized by the driver stimulation device can be further enhanced by using several periodical stimulation patterns.

In an embodiment, the electronic control unit is configured to assess periodically a confidence level (a system's confidence level), the confidence level representing an assessment by the automated driving system of its own capability to drive the vehicle safely, and to cause the driver stimulation device to be activated according to at least two periodical stimulation patterns, the stimulation pattern that is used being determined based at least on the confidence level.

In the previous sentence, for the automated driving system, ‘driving the vehicle safely’ means ‘controlling the vehicle so as to keep it in a certain safety zone within the upcoming time frame’.

The confidence level can therefore represent a probability that the automated driving system will be able to perform its function safely. The confidence level is therefore the inverse of what could be called the ‘level of anxiety’ of the automated driving system.

Thanks to the foregoing features, the driver is informed by the driver stimulation device of the confidence level assessed by the automated driving system. When the driver receives the information that this confidence level decreases, he or she is naturally led to increase his or her level of traffic situation awareness. Advantageously, this increased level of attention can be got imperceptibly, that is without increasing a mental load of the driver (which can be also related to the fact that the stimulation light sources can be located so as to be seen by the driver in peripheral vision rather than in foveal vision).

In particular, the electronic control unit can be configured, in order to determine the confidence level, to assess at least one of the following conditions:
a) a speed of the vehicle exceeds a predetermined threshold;
b) a temperature (outside the vehicle, inside a sensor, . . . ) exceeds a predetermined maximum temperature threshold;
c) a temperature (outside the vehicle, inside a sensor, . . . ) falls below a predetermined minimum temperature threshold;
d) a number of mobile elements detected by the automated driving system around the vehicle exceeds a predetermined threshold;
e) at least one of sensors of the advance assistance system has a failure; and
f) a risk of dysfunction of the automated driving system increases;
g) a specific traffic behaviour (for instance unstable traffic), is detected, in particular based on a relative speed between vehicles;
h) specific weather conditions, in particular light or rain conditions, are detected; and
i) a predetermined road infrastructure design is detected, in particular based on radius of curve(s) of road(s), etc.

Accordingly, the confidence level is then determined based on at least one of these assessments.

In some embodiments, the electronic control unit is configured to select a first stimulation pattern for a relatively high confidence level, and a second stimulation pattern for a lower confidence level, wherein the second stimulation pattern:
a) has a frequency higher than a frequency of the first stimulation pattern;
b) involves more light sources than the first stimulation pattern, the driver stimulation device comprising a plurality of light sources;
c) comprises emitting at least one stronger light or noise or haptic signal to the driver, the driver stimulation device comprising respectively a light source, a sound-emitting device, or a haptic signal-emitting device; and/or
d) comprises emitting light having a different colour, noise having a different frequency, and/or haptic signal having a different frequency, than respectively the colour, noise, or haptic signal of the first stimulation pattern, the driver stimulation device comprising respectively at least one light source, one sound-emitting device, and/or one haptic signal-emitting device.

In some embodiments, the sole difference or differences between the first and second stimulation pattern is only one or more of the differences defined by features a) to d).

Changing the frequency of the stimulation pattern has proved to be a particularly efficient way to stimulate the driver and to drive him or her to check the situation of the vehicle, and watch more frequently the road ahead the vehicle.

When the stimulation pattern is changed, the driver detects that the stimulation pattern has changed and can almost feel that the “vehicle's anxiety level” has changed. This anxiety level, inverse to the confidence level, depends on many factors. It increases when the traffic situation complexity increases, when the weather conditions become more difficult, etc.

Consequently, when the anxiety level increases (or the confidence level decreases), the driver will naturally react by checking more frequently the traffic situation, and by getting more and better prepared to take over, if requested by the system, or if the driver wants to; and vice versa.

Finally, the features of the automated driving system help the driver to determine the appropriate frequency for checking the state of the traffic around the vehicle, and therefore help the driver keep the mental load of driving as light as possible, while maintaining a high level of safety.

In particular, it has been found that selecting the frequency for the stimulation pattern close to a breathing frequency is particularly adapted to inform the driver of the confidence level assessed by the automated driving system. More particularly, the frequency of the driver stimulation pattern can change as a function of the confidence level of the automated driving system, just as the breathing frequency of a person changes, for instance increases when he or she is confronted with a more stressful situation.

When the frequency of the stimulation pattern of the driver stimulation system is set to be close to the breathing frequency of a person at rest, in a quiet situation, it suggests to the driver that the vehicle automated driving system has a high confidence level with respect to the driving of the vehicle.

The stimulation pattern can then have a relatively low frequency. The electronic control unit can for instance be configured, when a confidence level is determined to be higher than a predetermined threshold, to select a first stimulation pattern having a frequency below 0.4 Hz, and in some embodiments below 0.2 Hz.

Conversely, when the confidence level is lower, the frequency of the stimulation pattern of the driver stimulation system can in some embodiments be set to a higher value. Doing so informs the driver that the vehicle automated driving system feels a sort of higher ‘anxiety level’. Consequently, the driver is naturally led to be more vigilant and to gain more situation awareness, so as to be ready to take over if necessary.

### BRIEF DESCRIPTION OF THE DRAWINGS

The present disclosure may be better understood and its numerous other objects and advantages will become apparent to those skilled in the art by reference to the accompanying drawing wherein like reference numerals refer to like elements in the following figures and in which:

FIG. 1 is a schematic drawing in perspective of an automated driving system according to a first embodiment of the disclosure;

FIG. 2 a schematic drawing in perspective of an automated driving system according to a second embodiment of the disclosure; and

FIG. 3 is a summary table which shows how various stimulation patterns are progressively selected as a function of driving circumstances, during an exemplary trip.

### DETAILED DESCRIPTION

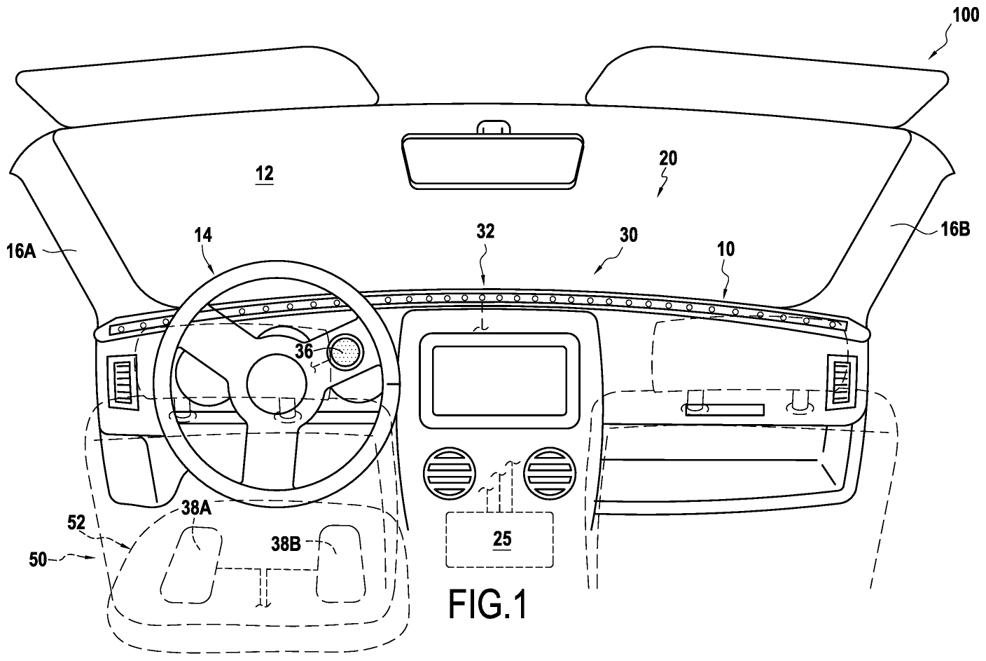

The first embodiment will be described in relation with FIG. 1.

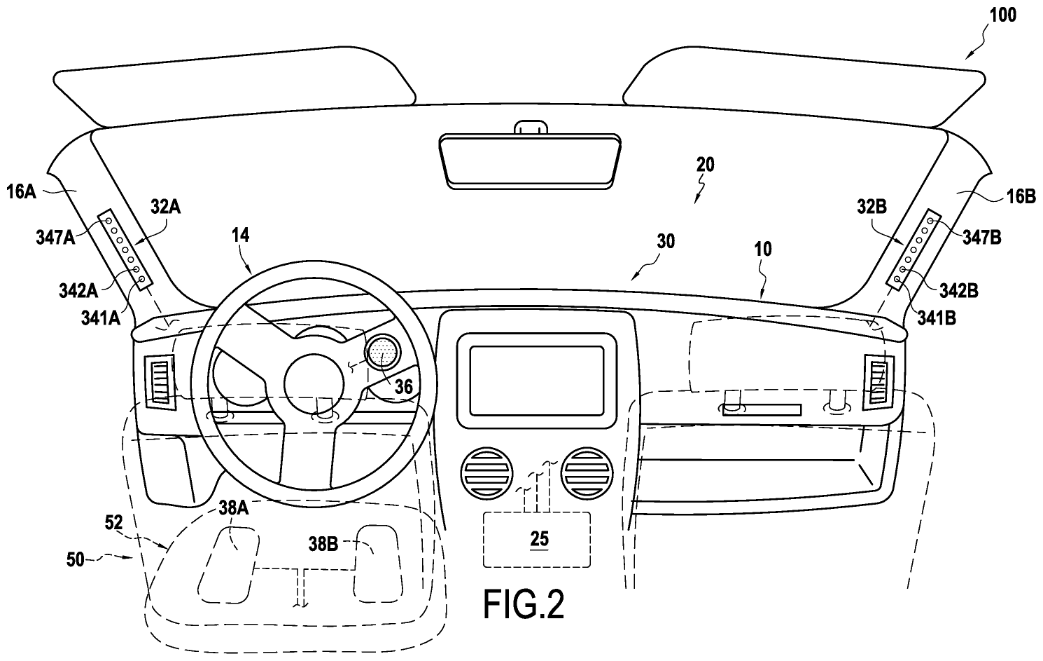

In the second embodiment (FIG. 2), elements identical or similar to those of the first embodiment are designated by the same reference numerals, and the description of these elements will be omitted.

In FIG. 1, the reference numeral 100 denotes a vehicle in which an automated driving system 20 is mounted.

The vehicle 100 comprises a dashboard 10, a windscreen 12, a steering wheel 14 and two pillars 16A and 16B located on the lateral sides of the windscreen 12.

The automated driving system 20 comprises an electronic control unit 25 and a driver stimulation device 30.

The electronic control unit 25 (ECU 25) is an automotive-grade control unit. It could also be formed by a plurality of control units. In some embodiments, it could possibly be located (or part of it) in a remote location, the remote elements communicating in real time with the elements aboard the vehicle.

The driver stimulation device 30 comprises several stimulation elements to stimulate the driver and keep him vigilant and aware at all times of the situation on the road. These stimulation elements are respectively a light-emitting device 32, a sound-emitting device 36, and a haptic signal-emitting device 38. All these elements are connected to the ECU 25.

The light-emitting device is formed by a stripe 32 comprising many LEDs (Light-emitting diodes), placed on the dashboard. The sound-emitting device is a loudspeaker 36 located in a radial arm of the steering wheel 14. The haptic signal emitting device 38 is formed by two vibrating plates 38A, 38B arranged in the seat bottom 52 of the driver's seat 50 (shown in dashed lines on FIGS. 1 and 2).

These locations have been been selected so that the stimulation signals be easily perceived by the driver. In particular, the location of the light-emitting device (the stripe 32) has been chosen so as to be easily perceived even when the driver performs a non-driving related task, such as looking down to operate a smartphone, or glancing to the passenger's side to discuss with a passenger, for example.

The automated driving system further comprises sensors, possibly other electronic control units, actuators, in a manner known per se (these elements are not represented). These other sensors, possible other ECUs and actuators enable the automated driving system to carry out its main function of assisting the driver.

In the present case, the automated driving system 20 is able to perform an Automated Driving function in which all controls of the car are handled automatically by the automated driving system. However, in this mode, the automated driving system 20 can sometimes require that the driver take over, in case the automated driving system 20 determines that it cannot safely drive the vehicle. Accordingly, the automated driving system 20 of the present example is a motor vehicle driving automation system classified at level 3 according to SAE norm J3016.

FIG. 2 represents an automated driving system very similar to the automated driving system represented by FIG. 1. The only difference between these two systems is the location of the light-emitting device 32. In the embodiment of FIG. 2 indeed, the light-emitting device 32 comprises two stripes 32A, 32B, each of them comprising seven LEDs (Light-emitting diodes). The LEDs are numbered 341A to 347A on the left-hand side stripe 32A, and 341B to 347B on the right-hand side stripe 32B. These LED stripes 32 replace the single LED stripe 32 of the first embodiment.

The automated driving system 20 functions as follows.

The driver stimulation device 30 is active while the Automated Driving function is active: it starts from the moment the Automated Driving function starts, by driver's demand (by pushing a specific button for example); and it terminates when the Automated Driving function stops, as actual driver's control takeover is effective (longitudinal and/or lateral control).

The stimulation provides a feedback to the driver about the Automated Driving function being on.

When the automated driving system 20 is activated, the electronic control unit 25 activates the driver stimulation device 30 according to one among four periodical stimulation patterns. The stimulation pattern which is chosen at any time depends on the confidence level determined by the automated driving system 20.

Conversely, when the automated driving is not in use, the driver stimulation system is set off, and no stimulation pattern is used: the LED stripe 32 is shut off, the loudspeaker 36 silent, the vibrating plates do not vibrate.

The four stimulation patterns consist in different stimuli, including light, sound and vibrations, as explained hereafter. These stimuli are mainly based on the visual modality, that is, on light emitted by the stripe 32 of LEDs placed on top of the vehicle's dashboard. This stripe 32 extends all along its width from the left pillar to the right pillar, as shown of FIGS. 1 and 2. The light is emitted by pulses with variable frequency. The light colour of the LEDs is also variable.

### Operation

The four stimulation patterns correspond to four increasingly low confidence levels. The fourth stimulation pattern constitutes a Take-Over Request by which the automated driving system 20 requires the driver to take over.

The ECU 25 chooses the stimulation pattern based on the confidence level that it determines by detecting, understanding, and predicting the traffic situation and the trajectories of the surrounding vehicles, pedestrians and/or any other moving element(s).

In this purpose, the ECU 25 iteratively (for instance every 0.02 seconds) runs an algorithm to determine the confidence level.

The four stimulation patterns are the following:

1. “No-event: light stimuli”: Half of the LEDs of LED stripe 32 are illuminated in white colour and blink at a 0.15 Hz pulse frequency. No sound or vibration is emitted.

This pattern is chosen when the confidence level determined by ECU 25 is below a first, high threshold A1. It is therefore usually chosen when the traffic conditions are very simple, such as on a straight road during a clear day with very good visibility, and no or few other vehicles are detected around. This pattern has a low frequency, which corresponds to breathing frequency at rest (0.15 Hz). This frequency and the colour of the LEDs are chosen to convey a neutral message to express calmness (i.e. not alerting).

2. “High-confidence event: mild stimuli”: Half of the LEDs of LED stripe 32 are illuminated in white colour and now blink at a 0.5 Hz pulse frequency. No sound or vibration is emitted.

This pattern is chosen when the confidence level determined by ECU 25 is between the first threshold A1 and a second, intermediate threshold A2. It is therefore usually chosen when the traffic conditions are getting more complex, such as on a curve, or by the presence of some other vehicles around, for example. Since the pulse—the blinking frequency—of the LEDs is now higher, the felt “breathing rate” is relatively higher; however, the other modality characteristics (colour, noise, vibrations) are kept neutral.

The white colour and the slightly higher frequency rate of the stimuli would emulate a less relaxed breathing rate compared to the “light stimuli” (Picture 1).

3. “Low-confidence event: strong stimuli”: All the LEDs of LED stripe 32 are now illuminated, in blue colour, and blink at a 0.5 Hz pulse frequency, and the loudspeaker 36 emits a muffled sound or beep. This beep is repeated periodically, also at a 0.5 Hz frequency. In some embodiments, the frequency of the beep itself is chosen to be rather low, such as 50 Hz. No vibration is emitted.

This pattern is chosen when the confidence level determined by ECU 25 is between the second threshold A2 and a third, low threshold A3. It is therefore usually chosen when the traffic conditions are very complex, getting close to the system's limits, such as on a curve during a rainy night with low visibility, and many other vehicles are detected around, for example. With the higher blinking frequency of the LEDs, the illumination of all LEDs rather than only five of them, the addition of the muffled sound, the higher frequency or “breathing rate” relatively high, the driver stimulation device 30 with this stimulation pattern expresses more alertness; the blue colour and the frequency rate of the stimuli emulate a more anxious and unconfident breathing rate.

4. “Over system's limits: Take-Over Request”: All LEDs of LED stripe 32 are illuminated in red colour and blink at a 1 Hz pulse frequency, the loudspeaker 36 emits a sound which is louder than the muffled sound or beep of stimulation pattern 3, is different from that muffled sound (for instance has a frequency of 100 Hz rather than 50 Hz), and is emitted at a 1 Hz frequency (rather than 0.5 Hz); in addition, the vibrating plates 38A, 38B vibrate during vibration periods, also at a 1 Hz frequency.

This pattern is chosen when the confidence level determined by ECU 25 falls below the third threshold A3. It is therefore usually chosen when the automated driving system's limits are reached, for instance due to a sudden unexpected obstacle or event, failure of a sensor, etc. With this stimulation pattern, the stimulation frequency or “breathing rate” is further increased; the combination of signals of the pattern all tend to alert the driver and request him or her to urgently take over the control of the vehicle. The red colour and the higher frequency rate of the stimuli emulate a very anxious breathing rate. The fourth stimulation pattern constitutes a request for the driver to immediately take over.

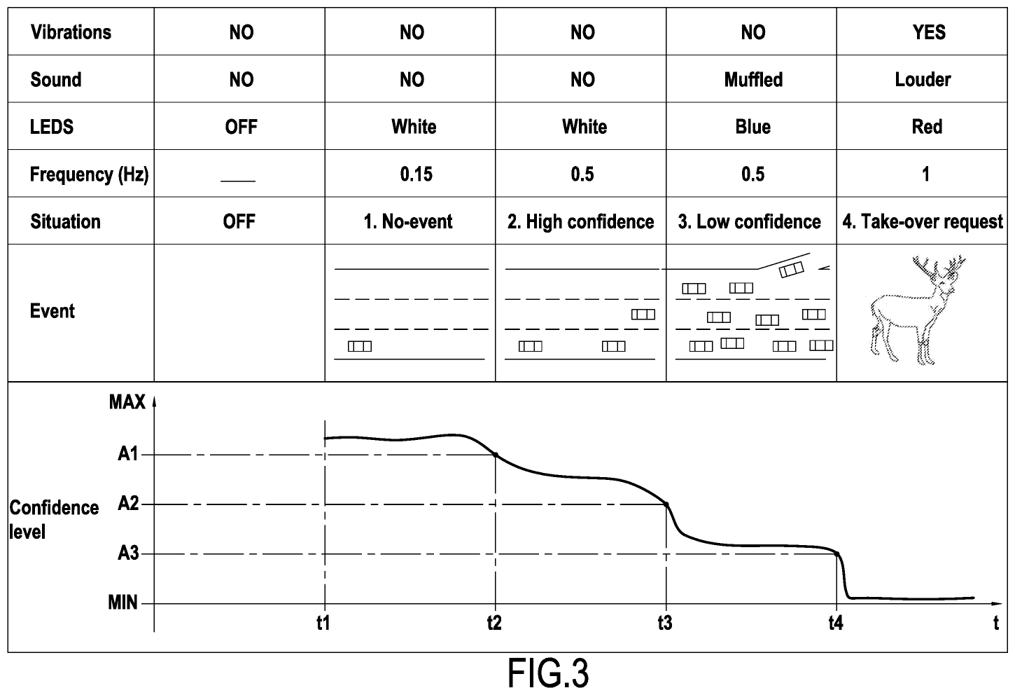

These stimulation patterns are illustrated by FIG. 3, which represents a fictional drive by a driver, in a vehicle equipped with automated driving system 20.

During this trip, the driver initially and until time t1 does not activate the automated driving system 20. During this period, the driver stimulation device 30 remains inactive.

At time t1, the driver which has reached a highway triggers the automated driving system 20. The driver stimulation device 30 is immediately activated. The confidence level is immediately determined and found to be very high, greater than A1. The ECU 25 thus selects stimulation pattern 1, ‘No event’.

At time t2, the traffic becomes slightly denser, though being still very calm. The confidence level decreases slightly and falls below A1, though still above A2. The ECU 25 thus selects stimulation pattern 2, ‘High confidence’.

Consequently, the driver is stimulated and tends to increase his or her situation awareness.

At time t3, the traffic becomes denser, and the vehicle comes closer to a branch. The confidence level decreases and falls below A2, though still being above A3. The ECU 25 thus selects stimulation pattern 3, ‘Low confidence’. The driver is stimulated more strongly than after time t2, and tends to increase his or her situation awareness even more than after time 2.

At time t4, an animal crosses the road in front of the vehicle. The animal is detected by the automated driving system 20. The confidence level immediately falls below A3. The ECU 25 thus selects stimulation pattern 3, ‘Take-over request’ and therefore requires the driver to take over control of the vehicle in order to avoid the animal.

The four stimulation patterns presented above are of course only an exemplary embodiment of the present disclosure. Many other settings can be chosen for the stimulation patterns which can also be quite effective for maintaining the driver at an appropriate level of traffic-situation-awareness at all times. The combination of signal emitting devices (here, one or two LED stripes, a loudspeaker and two vibrating plates) can be different. In particular, it can be sufficient to include only light emitting devices, or only a combination of light-emitting device and a sound-emitting device, for instance. Also, the automated driving system can further include one of more display (including head-up display) to display more detailed information about the driving situation, the situation of the automated driving system, etc.

1. An automated driving system comprising an electronic control unit and a driver stimulation device suitable for stimulating a driver by being activated according to at least one stimulation pattern, wherein the electronic control unit is configured to cause said driver stimulation device to be activated according to at least one periodical stimulation pattern, when the automated driving system is activated.

2. The automated driving system according to claim 1, wherein the driver stimulation device comprises at least one stimulation signal-emitting element among a light source, a sound-emitting device, and a haptic signal-emitting device.

3. The automated driving system according to claim 1, wherein said at least one periodical stimulation pattern comprises changing an intensity and/or a colour of light, changing an intensity and/or a type of sound, and/or changing an intensity and/or a type of haptic signal.

4. The automated driving system according to claim 1, wherein the electronic control unit is configured to assess periodically a confidence level representing an assessment by the automated driving system of its own capability to drive a vehicle safely, and to cause the driver stimulation device to be activated according to at least two periodical stimulation patterns, the at least one stimulation pattern that is used being determined based at least on the confidence level.

5. The automated driving system according to claim 4, wherein the electronic control unit is configured to select a first stimulation pattern for a relatively high confidence level, and a second stimulation pattern for a lower confidence level, wherein the second stimulation pattern:
a) has a frequency higher than a frequency of the first stimulation pattern;
b) involves more light sources than the first stimulation pattern, the driver stimulation device comprising a plurality of light sources;
c) comprises emitting at least one stronger light or noise or haptic signal to the driver, the driver stimulation device comprising respectively a light source, a sound-emitting device, or a haptic signal-emitting device; and/or
d) comprises emitting light having a different colour, noise having a different frequency, and/or haptic signal having a different frequency, than respectively a colour, noise, or haptic signal of the first stimulation pattern, the driver stimulation device comprising respectively at least one light source, one sound-emitting device, and/or one haptic signal-emitting device.

6. The automated driving system according to claim 4, wherein the electronic control unit is configured, in order to determine the confidence level, to assess at least one of the following conditions:
a) a speed of the vehicle exceeds a predetermined speed threshold;
b) a temperature exceeds a predetermined maximum temperature threshold;
c) a temperature falls below a predetermined minimum temperature threshold;
d) a number of mobile elements detected by the automated driving system around the vehicle exceeds a predetermined threshold;
e) at least one of sensors of the automated driving system has a failure;
f) a risk of dysfunction of the automated driving system increases;
g) a specific traffic behaviour is detected;
h) specific weather conditions are detected; and
i) a predetermined road infrastructure design is detected.

7. The automated driving system according to claim 1, wherein the electronic control unit is configured, when a confidence level is determined to be higher than a predetermined threshold, to select a first stimulation pattern having a frequency below 0.4 Hz.

8. The automated driving system according to claim 1, wherein the electronic control unit is configured, when a confidence level is determined to be higher than a predetermined threshold, to select a first stimulation pattern having a frequency below 0.2 Hz.
